(19) United States
(12) Patent Application Publication
(10) Pub. No.: US 2013/0122159 A1
(43) Pub. Date: May 16, 2013

(54) PROCESS AND EQUIPMENT FOR STERILIZING LIQUID FOODS AT LOW TEMPERATURE THROUGH DECOMPRESSION AND/OR GREAT LINEAR OR ROTATORY ACCELERATIONS

(71) Applicant: Francisco José Duarte Vieira, Belo Horizonte (BR)

(72) Inventor: Francisco José Duarte Vieira, Belo Horizonte (BR)

(21) Appl. No.: 13/699,245

(22) PCT Filed: May 19, 2011
(86) PCT No.: PCT/BR11/00161

§ 371 Date: Jan. 28, 2013

(30) Foreign Application Priority Data
May 21, 2010 (BR) PI1002602-9

(51) Int. Cl. A23L 3/015

(52) U.S. Cl. CPC A23L 3/0155
USPC 426/238; 426/524; 426/474; 426/241; 426/248; 426/520; 99/485

(57) ABSTRACT

The present disclosure employs two principles:

The first principle consists of producing a great and sudden decompression which causes a great and sudden expansion of the gases present in the cytoplasmic and organelle liquids of the contaminative organisms, thereby causing the death of the contaminative organisms. This process can be accomplished at low temperatures near the freezing points of the liquids to be treated, thereby preserving all the molecules of the nutrients that get lost with the higher temperature used in the pasteurization process.

The second principle consists of subjecting the liquids to be treated, conformed in droplets or fine sprays, to great linear or rotatory accelerations, or both, which can reach up to 1,000 times the gravitational acceleration on Earth's surface, through frontal, tangential or oblique shocks. These shocks have lethal effects on the cell membranes, organelles and, mainly, cytoskeleton and organelle architecture of the contaminative organism cells.

### CROSS REFERENCE APPLICATIONS

This application is a national stage application of PCT application no. PCT/BR2011/000161 filed May 19, 2011, which claims the benefits of P11002602-9 filed May 21, 2010, each of which is hereby incorporated by reference for all purposes.

### BACKGROUND

State of the Art.

The continuous discoveries of Man's ancestor fossils places the origin of the Homo genus back to 5 million years ago; thus, it took man 5 million years to reach the current population of about 6 billion individuals.

Under favorable conditions, one single bacterium, dividing itself by scissiparity every 20 minutes, reaches this population in only 11 and a half hours.

The current human population is a result of learning how to get and preserve food, among other factors.

For Man, obtaining food in abundance had to wait until the beginning of the past 100 centuries, with the Agricultural Revolution and the beginning of the domestication of animals purposed to food intake.

Obtaining and preserving food have turned out to be, since the earliest years of Man, a non-stop competition against other men, animals and, mainly, against insects and microorganisms.

The work and the mortal risks of harvesting or hunting had to be continuous as the storage for the hard times was impossible due to food decay.

Due to putrefaction, both vegetables and animal carcasses become unsuitable for consumption in a short time.

Certainly, the inaugural means of the protein preservation technologies was accidental: the remains of fish left on the shore, on rocks covered with salt and heated by the sun proved to be preserved and edible for several days.

Meat cooked over the heat and steam of green wood was preserved for several days; it would last even longer if it was soaked in hot, melted fat of the animal and kept in the first ceramics.

Heat, as it has been until today, was the main weapon of man in his competition for food against bacteria.

During the Industrial Revolution, canned food cooked inside the cans themselves for around 30 minutes at temperatures that reached 120° C. and then sealed were developed in England.

The reason for the food being preserved under such conditions was discovered by Louis Pasteur (1822-1895), a founder of the science and practice of microbiology., Pasteur discovered that the reason for food decay, the “mystery” of fermentation and a great part of disease, was the activity of microorganisms.

Due to Pasteur's studies, the food preservation technology improved scientifically. Preservation was a result of the death or suspension of the vital activity of microorganisms like bacteria or fungi obligatorily followed by the prevention from recontamination.

Going on with his research, Pasteur developed a technology for eliminating bacteria from liquid foods such as wine, milk, beer, juice, among others, called “pasteurization”. Pasteurization consists of the elevation of the liquid temperature to around 70° C. followed by a quick lowering of its temperature and, after that, by keeping the liquid in hermetically sealed containers, preferably cooled ones.

Pasteur developed the “pasteurization” technology based on great scientific fundamentals, as he was being pressed by the French government to solve a critical economic problem of the time: wine production, which was fundamental to the French economy, was suffering with the acetic fermentation.

Boiling the grape juice before the winemaking process would have been simple. Research had shown that the acetic fermentation was completely eliminated through boiling and, in fact, Pasteur experimented with such a process, but the high temperatures of the ebullition eliminated all the precious molecules that made the French grapes the ones to produce the most valuable wines in the world.

Pasteur searched for a way to sterilize at a temperature that was lower than the water ebullition point because he learned that it was not possible to obtain good quality wines if the grape juices had been previously heated up to the water ebullition temperature.

Since the birth of pasteurization, the greatest weapon against the bacteria that contaminate liquid foods man has ever invented, it has been understood that pasteurized products suffer losses of valuable compounds because of the high temperatures during the process.

The pasteurization process has as its practical, scientific core the fact that, by rising the temperature, the microorganisms trigger their duplication mechanisms; as the temperature is lowered abruptly, such mechanisms interrupt their duplication process irreversibly, thus stopping the survival or the cell reproductive possibility of the microorganisms.

Certain microorganisms that contaminate foods do not necessarily cause food putrefaction or fermentation and are, therefore, imperceptible, but they can subsist until they find favorable conditions for reproduction, coming to cause pathologies in those who consume them, such as the genera of bacteria including Escherichia, Salmonella and others; the protozoan Trypanosoma cruzi, derived from hematophagous hemiptera excretion, which is able to orally contaminate the consumers of the açai palm tree fruit juices.

Pasteurization is the leading process for milk preservation worldwide because it is fast, safe, automatic and energetically economic.

Pasteurization is not sterilization; during pasteurization, nearly 99.5% of the contaminating microorganisms are eliminated and the product must be kept under refrigeration, which brings high costs for transportation and storage. The thermal sterilization is an evolution of the pasteurization and during the UHT—“Ultra High Temperature” modem process, the temperature goes up to 140° C.; however, the high temperatures of the process deeply change the natural products treated by it, changing their color, taste and smell and destroying their natural active principles.

Regarding the milk treated by the UHT process, its shelf life discards refrigeration and lasts more than 120 days; however, the milk is so modified that it is not useful for the production of any dairy goods.

There are other sterilization technologies at lower temperatures: filtering, irradiation of liquid foods inside glass containers by Gama Rays from the natural radiation of Cobalt 60 or by beams of accelerated electrons, elevation of the pressure over the liquid foods already in the flexible polymer containers, in hyperbaric chambers, at up to 600 Mpa-or 6,000 atmospheres (which is equivalent to 10 times the pressures used to extract the oil from the “Pre-Salt”). These processes can be carried out over foods at room temperature.

The gama radiation and the bombardment of beams of accelerated electrons destroy the DNA and the RNA of the microorganisms that then, besides being unable to reproduce, die.

The application of hydrostatic pressures at around 6,000 atmospheres destroys the microorganisms.

Each of these technologies has problems such as costs, process speed and investment costs, which make them unpopularin the market.

Reviews of the State of the Art.

The changes of man's pace of life stemmed from the creation of megalopolises, which gave birth to the industrialized food market and to the general use of chemical products, such as preservatives, colorants, acidulants, stabilizers, thickeners etc.

Those who fight for a healthier food diet have shown the correlation between fiberless foods and colon cancer and they have reported the losses of the most valuable active principles of the foods because of the high temperatures of the industrial processes; to all this, the food industry replied with the addition of fibers, minerals, vitamins etc.

Proponents of a food diet that is as much natural as possible claim that vegetable foods like fruits, stems, leaves, roots, and dried or sprouted seeds must be consumed as soon as possible, right after harvest, in order to keep their most valuable molecules intact. Further, these vegetable foods cannot have any kind of chemical product added, they cannot be in contact with oxygen, they cannot even be heated, as the heating and oxidation destroy the enzymes, vitamins and other active molecules, such as the antioxidants, which are specific to these vegetable foods.

Foods that have the properties described above are known as “superfoods”, however, until the appearance of the process and equipment described herein, the industry has not been able to produce such foods due to the high temperatures needed for the pasteurization.

The powerful technology of pasteurization cannot meet the requirements mentioned above, for, in this process, the great elevation of the temperature, mainly when regarding milk and fruit juices, modifies the taste, the color and the smell and it destroys a great part of the enzymes, vitamins, antioxidant molecules and almost all the active principles that are characteristic in the live or recently picked vegetable.

In sum, we focus our criticism on the State of the Art of the pasteurization of liquid foods because it is applied to the 440 billion liters of milk and to the 130 billion liters of beer produced annually.

Advances in the State of the Art brought up by the object of the present disclosure.

The process and equipment described herein is the result of research in the following areas:

1—search for an alternative for Pasteur's work, who stated that the minimum temperature for preserving foods through heat is around 70° C. and that it is impossible to do it at lower temperatures;

2—the relevance of preserving the most valuable molecules of natural foods, from Casimiro Funk's work, the discoverer of the powerful effects of certain substances existing in the natural foods which are destroyed by the industrial processes applied to them, such substances he named “vitamins”; currently, the discovery and preservation of the antioxidants have similar relevance as the discovery of the vitamins had in their time;

3—Paul Bert's and J. S. Haldane's studies on the causes of the “diver's disease”; and

4—search for other simple physical, economical and lethal phenomena about microorganisms capable of acting at low temperatures.

Regarding Pasteur's studies, the one described above is enough; further we will briefly describe Casimir Funk's, Paul Bert's and Haldane's studies and, throughout this disclosure references to other scientific bases of the physical-chemical phenomena this disclosure is based upon will be made.

Vitamins:—the Vital Substances.

Unforgettable are the discoveries made by Casimir Funk, English doctor in colonial India, in charge of a Shelter-Hospital for terminal patients, who got sick because of a strange tropical disease, known as beriberi. As he powerlessly watched his patients emaciate, he saw through his office window the sick hens in the hospital's hen house. The sick hens were treated with the same peeled rice given as food to his patients, whereas, on the other side of the fence, the hens belonging to the hospital employees were fed with the residues from the treated rice, which was mandated by the English law. The hens belong to the hospital employees were fat and healthy.

In one simple, definitive experiment, Casimir Funk started feeding his patients with brown rice again and saw, in a few weeks, the hospital releasing almost all his patients, who were “miraculously” cured.

Later, Funk extracted a compound of the amino group he named “vitamins” from the rice treatment residues and he confirmed the ancient knowledge about the valuable natural properties of foods, which get lost throughout the industrialization process.

Funk's work gave birth to the micronutrient attention era, that is, health fundamental compounds that are present in foods at minimum quantities and that are destroyed by the temperature rise and by other industrial processes.

The “Diver's Disease”.

Modern man only started to question the “diver's disease” when the railroads needed pillars with submerged bases to support bridges over rivers and seas.

The workers, with their rudimentary equipment of the time, usually pneumatic boxes, or special clothes called “diving suits”, were able to dive deeper and deeper in order to build the pillars, staying under water and breathing air under pressure for long periods of time without suffering any side effects while diving. However, when they returned to the surface, they were attacked by a mysterious disease with numerous harms and came to sudden death.

The French scientist Paul Bert, in 1878, showed that such harms only occurred if the divers stayed under water for long periods of time breathing insufflated air under high pressures, which were necessary to fight the hydrostatic pressures, then went quickly back up to the surface.

Necropsies confirmed the scientist's observation: the ones who died from the “diver's disease” had the blood circulation blocked by the formation of big gas bubbles in the blood vessels as an effect of the decompression. It is analogous to opening a bottle of champagne; the gas dissolved in the liquid under pressure suddenly expands forming big bubbles, according to the General Gas Law, in order to occupy a larger volume in the atmospheric pressure.

Just as the slow opening of a bottle of champagne allows the bubbles to come out slowly, without forming a profusion of big bubbles, the “diver's disease” could be completely avoided if the divers went back to the surface slowly. The slow ascension led to a slow decompression and, thus, the insufflated gases that remained in the solution of the body liquids under pressure were eliminated by the lungs before large gas bubbles got together, through coalescence, inside the vessels and tissues, blocking the distal blood irrigation to these vessels.

Later, with the great commercial and strategic value of dives, which were longer and longer and deeper and deeper, the British government assigned Professor John Scott Haldane to solve the problem; he elaborated a table that determined the “PERIODS OF TIME OF ASCENSION DUE TO DEPTH AND PERMANENCE TIME UNDERWATER”, solving the problem pragmatically, that is, so that no one died after emerging.

Soon after eliminating the acute threat of the “diver's disease”, which occurred right after emerging, the “diver's disease” was forgotten. It only recently caught scientists' attention again when, years later, its chronic effects appeared in the form of numerous harms that attacked the professional divers and reduced their lifetime span in the long term.

Just like Bert's, Haldane's work, with outstanding practical outcomes, was focused on the systemic and macroscopic causes of the disease, that is, gas embolisms that were blatant even to the naked eye, on the necropsied corpses.

Researches on the diver's chronic diseases had to widen their observation level to the histological level, determining, for instance, that the chronic diseases of the long bone epiphysis were caused by the expansion of the gases in the reduced bone tissue spaces. These reduced bone tissue spaces are not very elastic, thus the expansion of the gases squeezes the local arterioles and venules and blocks blood circulation, with a consequent ischemic death of the cells in the region.

New regimes of diving and ascending as well as new gases—like mixes of Helium, Nitrogen and Oxygen, called “Trimix Gas”—started to be used and, thus, the chronic harms derived from diving could be prevented by a periodic follow-up of the divers' health through bone x-rays.

Once the disease was controlled, the scientific interest in the issue was again reduced and it stopped on the histological level.

Pasteurizing is Not Sterilizing.

Sterilizing—as its own name says, is “the act of becoming sterile, without allowing life”—it is a dichotomic phenomenon: either it is perfect and all the organisms are killed or it is not sterilization.

Pasteur, in his famous and definitive public presentation of the inexistence of the spontaneous generation phenomenon, would have failed if one single microorganism had remained alive in the solution he used in the presentation, because the recovery of the contaminative organism population leads to their great growth in number in just a few hours.

In Pasteur's presentation, if there were one single surviving bacterium that reproduced by scissiparity every 20 minutes, in only 11 and a half hours the descending population would be that of 6 billion individuals.

### SUMMARY

Fields of this Patent:
Cold sterilization of liquid foods through decompression.
Cold sterilization of liquid foods through great linear, rotatory accelerations or any combination of them.

The “PROCESS AND EQUIPMENT FOR STERILIZING LIQUID FOODS AT LOW TEMPERATURE THROUGH DECOMPRESSION AND/OR GREAT LINEAR OR ROTATORY ACCELARATIONS” described herein releases the Man from the undesirable heating effects of sterilizing liquid foods and enables the preservation of all their valuable natural properties like it has never been done before in human history by using great cold decompressions and/or great linear or rotatory accelerations.

The present disclosure describes two methods for sterilizing liquid foods at low temperature:

a—through great and sudden decompressions of the gases present inside the cells of the contaminating microorganisms, making their cell membranes and their organelles explode, killing them at cold and preserving all their “in natura” characteristics;

b—subject the cells of the contaminating microorganisms to accelerations that are up to 1,000 times the Gravity acceleration on Earth's surface, accelerations that may produce linear, rotatory movements or both combined, in order to destroy their cytoskeleton and their organelle architecture.

The first of the two core principles of the “PROCESS AND EQUIPMENT FOR STERILIZING LIQUID FOODS AT LOW TEMPERATURE THROUGH DECOMPRESSION AND/OR GREAT LINEAR OR ROTATORY ACCELARATIONS”, object of this disclosure, consists of producing a great and sudden decompression in order to cause a large and sudden expansion of the gases, whether natural or insufflated, which are present in the cytoplasmic liquids and in the liquids inside the organelles of the contaminative organisms and to cause the death of all of the contaminated organisms. Such process is carried out at low temperatures that can be close to the freezing points of the liquids to be treated in order to preserve all the molecules of the nutrients that get lost with the rising of the temperature in the pasteurization method.

The second of the two core principles of the “PROCESS AND EQUIPMENT FOR STERILIZING LIQUID FOODS AT LOW TEMPERATURE THROUGH DECOMPRESSION AND/OR GREAT LINEAR OR ROTATORY ACCELARATIONS.”, object of this disclosure, consists of subjecting the liquids to be treated, shaped in droplets or fine sprays, to great linear or rotatory accelerations, or both combined, which can get to 1,000 times the gravitational acceleration on Earth's surface, through frontal, tangential or oblique shocks with the pieces of the equipment, which have lethal effects on the cell membranes, on the organelles and their membranes and, mainly, on the cytoskeleton and organelle architecture of the contaminative organism cells, as it will be properly described further herein.

The two core principles of the “PROCESS AND EQUIPMENT FOR STERILIZING LIQUID FOODS AT LOW TEMPERATURE THROUGH DECOMPRESSION AND/OR GREAT LINEAR OR ROTATORY ACCELARATIONS”, objects of this disclosure, bring significant advances to the State of the Art by consisting of two extremely quick ways of sterilizing liquids, which can take such a short time as milliseconds. Additionally, they are safer and more economical relative to the investments on equipment, workforce and energy required by pasteurization, which is the leading technique.

### BRIEF DESCRIPTION OF THE DRAWINGS

Illustrations and work of the “PROCESS AND EQUIPMENT FOR STERILIZING LIQUID FOODS AT LOW TEMPERATURE THROUGH DECOMPRESSION AND/OR GREAT LINEAR OR ROTATORY ACCELARATIONS”, object of the present disclosure.

FIG. 1 is a schematic view of a first embodiment of equipment for sterilizing liquid foods at low temperature through decompression and/or great linear of rotator acceleration according to the present disclosure.

FIG. 2 is a schematic view of a second embodiment of equipment for sterilizing liquid foods at low temperature through decompression and/or great linear of rotator acceleration according to the present disclosure.

FIG. 3 is an excerpt of a table depicting “Water Ebullition Temperature due to Pressure”.

FIG. 4 is a schematic view of a eukaryotic cell.

FIG. 5 is a schematic view of the phospholipid bilayer which forms the cell membrane of the eukaryotic cell of FIG. 4.

FIG. 6 is an immunofluorescent image of the eukaryotic cell of FIG. 4.

### DETAILED DESCRIPTION OF THE DRAWINGS

Description of the work and illustrations of preferred embodiments of the method and equipment of the present disclosure.

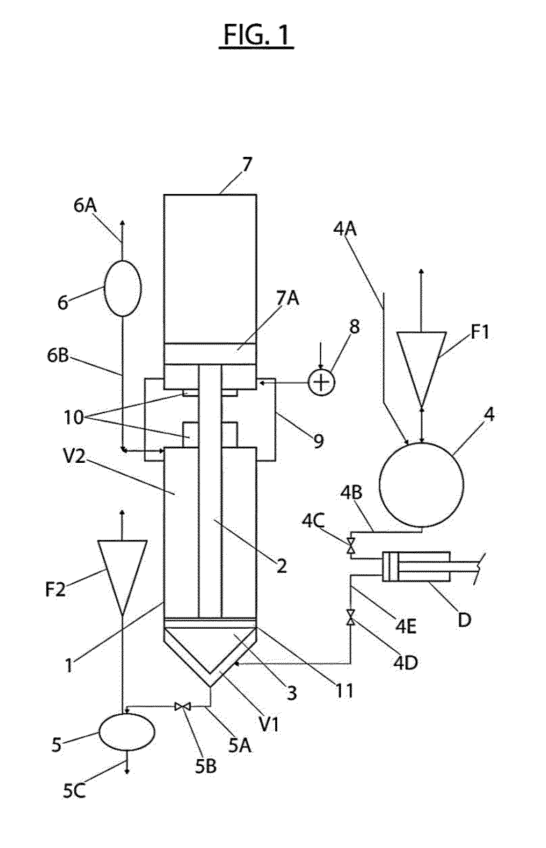

FIG. 1 illustrates the first of the two core principles which the innovations, object of this disclosure, are based upon, and it constitutes the preferable way of application of the Process and pieces of Equipment, object of this Patent, to liquids at atmospheric pressure. FIG. 1 is a frontal schematic view that illustrates the first of the two basic, core principles of the work of the object of this process and equipment of the present disclosure. FIG. 1 is a preferred embodiment, which is able to industrially process large volumes of liquids per minute. The equipment includes a decompression tank (1), usually made of stainless steel and, inside it, the piston (3), the rod (2), the tank of liquid to be treated (4). A duct (4A) transports the liquid to be treated into tank (4). The liquid to be treated is taken from tank (4) through the feeding duct (4B), under the control of the valve control (4C), and is taken through the piston-dosing cylinder (D) that doses and compresses the liquid to be treated. The liquid then travels through the duct (4E) under the control of the valve (4D) and into decompression tank (1). Treated liquid exits decompression tank (1) through exit duct (5A), through valve (5B), which takes it to storage tank (5). In storage tank (5), the pressure of the treated liquid is equalized to the atmospheric pressure by means of the air sterilizing filter (F2). Air sterilizing filter (F2) connects to the ambient atmosphere and to the interior of storage tank (5). Treated liquid leaves storage tank (5) for bottling through duct (5C).

FIG. 1 also depicts air sterilizing filter (F1), which balances the internal pressure of tank (4) with ambient atmospheric pressure. An oil pump (8) powers hydraulic decompression cylinder (7), which includes a piston (7A) and rod (2). A sterile gas tank (6) release sterile gas through relief duct (6B), into the upper part of the interior of the decompression tank (1) by the rise of piston (3). The sterile gas only has contact with the walls of decompression tank (1) and with its internal elements, it is kept sterilized as it circulates, through relief duct (6B), between the sterile gas tank (6) and the upper part of the decompression tank (1). Therefore, the sterile gas does not contact atmospheric gases and does not get contaminated by the environmental microorganisms. The sterile gas tank (6) can be fed sterile gases through duct (6A). In the depicted embodiment, sterile gas tank (6) contains nitrogen.

FIG. 1 also depicts volume V1, which corresponds to the volume of the liquid to be treated at each decompression cycle. Volume V2 depicts the decompression volume of the equipment, which corresponds to nearly 100 and 200 times the volume V1. High sealing gaskets (10) and sealing ring (11) of piston (3) are also visible. Aseptic sealing (9), which stops the rod (2) from being in contact with the atmospheric air and prevents the contamination of the equipment, is also depicted in FIG. 1.

The device illustrated by FIG. 1 functions as follows: the liquid to be sterilized is taken to tank (4), at room temperature or with the temperature lowered until close to its freezing point through duct (4A). The balance between the internal pressure of tank (4) and the atmospheric pressure is accomplished by air sterilizing filter (F1), such that the liquids to be treated, will always be insulated aseptically from contact with environmental air and at a pressure that is the same as the atmospheric pressure. It is due to atmospheric pressure that liquids to be treated travel through duct (4B) under the control of valve (4C) and enter the piston-dosing cylinder (D), which doses the liquid travelling to decompression tank (1) in each operational cycle.

As the filling operation of the dosing cylinder (D) ends, valve (4C) is shut, valve (4D) is opened, and the liquid to be treated is injected inside decompression tank (1). Piston (3) may be at any height between its lowest point and its highest point. If piston (3) is on or about its highest point the liquid to be treated is injected into decompression tank (1) with decompression tank (1) in a nearly vacuum state.

Preferably, the liquid to be treated is injected into the decompression tank (1) with the piston (3) being close to its lowest point, filling the volume (V1).

Each complete operational cycle of the equipment described in FIG. 1 has the two hemicycles described as follows:
Decompression hemicycle:—When the liquid to be treated, properly dosed, enters decompression tank (1), valves (4C), (4D) and (5B) are closed and, by the activity of oil pump (8) and hydraulic decompression cylinder (7), the piston (3) is risen at great speed—in tenths of a second—up to its highest point in order to produce a sudden and great increase of the volume over the liquid to be treated, decreasing its pressure between 100 and 200 times its initial pressure. This decrease in pressure causes the vaporization of the liquid to be treated and of the intracellular liquids of the contaminative organisms as well as the expansion of the gases within the contaminative organisms, causing the explosion of the cells and organelles of the contaminative microorganisms present in the liquid, thus sterilizing it at a cold temperature.

The neutral gas contained in the upper part of decompression tank (1) and around piston (3) is taken to sterile gas tank (6), through duct (6B), thereby relieving the operational pressures of the system.

Re-compression hemicycle:—Once piston (3) has reached its highest point and produced as much decompression of the equipment as possible, the piston (3) goes down to its lowest point, at the same speed as it was risen by operation of oil pump (8) and hydraulic decompression cylinder (7). and the lowering of piston (3) strongly compresses the gases that were removed from the liquids to be treated during the decompression hemicycle, liquefying such liquids and re-gasifying the liquids to be treated to the same original pressure before the treatment, that is, the atmospheric pressure. When piston (3) reaches the height that produces the volume (V1), valve (5B) opens, releasing the treated liquid through duct (5A), toward treated liquid tank (5). Treated liquid tank (5) has its internal pressure balanced with the atmospheric pressure by means of air sterilizing filter (F2). Piston (3) keeps going down to its lowest point and completely empties the interior of the decompression tank (1), leaving it ready for the beginning of a new cycle.

It can be seen, thus, that as it rises, the piston (3) produces the sterilization; as it goes down, it compresses the gases over the liquids again, gasifying them at cold, at atmospheric pressure, under which they are bottled.

In this embodiment of the “PROCESS AND EQUIPMENT FOR STERILIZING LIQUID FOODS AT LOW TEMPERATURE THROUGH DECOMPRESSION AND/OR GREAT LINEAR OR ROTATORY ACCELARATIONS”, hydraulic decompression cylinder (7) and oil pump (8), used for moving piston (3), can be replaced by a worm thread rising mechanism, pneumatic cylinders or any other suitable alternative.

The great and sudden decompression that causes the expansion of the gases inside the microorganisms can be achieved by a great and sudden increase of the volume above the surface of the liquids to be treated by the movement of a piston.

The gases present inside the contaminative microorganisms of the liquids to be treated through sudden and great decompressions or through great linear or rotatory accelerations may be originated by one, more than one or, simultaneously, by all the methods described below:

1—metabolic origin, by cellular breathing that generates especially Carbon Dioxide;

2—by the diffusion of the gases present in the liquids to be treated, which penetrate inside the cells and their organelles by passively diffusing through their membranes as a consequence of the pressure over the liquids to be treated;

3—artificially by gasification carried out in any way, at any pressure, before subjecting the liquids to be treated to great, sudden decompressions.

When the liquids to be treated by the process and equipment of the present disclosure are at atmospheric pressure, the metabolic gases and the ones diffused through the membranes into the microorganism cells are found dissolved in these liquids. When a prior gasification of the liquids to be treated is done, quickly or slowly, under pressures that can reach up to 200 kilograms per square centimeter, there will be, simultaneously, dissolved gases and metabolic gases inside the microorganisms.

The great and sudden gas expansions caused by the decompression in the containers, where the liquids to be treated lie, can be done at any rate, it is possible to make the intracellular gas volumes expand suddenly, from few times to around 20,000 times of their initial volumes.

Previously subjecting the liquids to be treated to gasification under pressures of about 200 kilograms per square centimeter or more makes the contaminative microorganisms of the liquids to be treated by the “PROCESS AND EQUIPMENT FOR STERILIZING LIQUID FOODS AT LOW TEMPERATURE THROUGH DECOMPRESSION AND/OR GREAT LINEAR OR ROTATORY ACCELARATIONS” suffer the effects of the decompression that are up to 200 times greater than when, from the atmospheric pressure, they themselves go through decompression of up to one hundredth of the atmospheric pressure.

High rates of sudden decompression after the infusion of gases under high pressure inside the microorganisms, whether they are viruses—like the aphthosis, occasionally present in the milk—or bacteria in their living forms or encapsulated, fungi and their spores, or protozoan—makes them all, without exceptions, explode at cold, through the sudden decompression, and die.

Previous gasification can be done in the liquids to be treated with neutral gases like nitrogen alone or mixed with other gases that are common in the liquid food industry, such as carbon dioxide, by several methods, such as compression by cylinders and pistons, by rotary pumps or by the permanence in gas tanks and it can make this gasification get to pressures of up to 200 kg per square centimeter or more. These pressures can be applied slowly or quickly.

In the slow way, the liquid foods to be treated are kept in gasification vessels, at rest or agitation, as the gases are injected slowly until they reach high pressures and they stay as long as it takes, which is specific for each kind of gas and liquid, so that the gases get diffused inside the cells (and the organelles) of the contaminative organisms, until their pressure inside these structures is equivalent to the gasification pressure present in the gasification vessels.

In the fast way, the liquids are quickly compressed, together with the gases, by pistons inside the pressurizing cylinders, injector nozzles or high pressure rotary output pumps.

The sudden and lethal gas expansion inside the cytoplasms, as well as inside the cell organelles approximately complies with the General Gas Law, in which the volume “V” of a certain gas mass, at a temperature “T”, can be expressed by the equation V=nRT/P, where “n” is the number of gas moles, “R” is the Universal Gas Constant and “P” is the initial pressure of the gas in the system under observation.

Through this equation, it can be noted that at the same “T” temperature, when “P” is reduced, “V” proportionally increases.

The scientific references utilized to obtain the subject of the present disclosure include the following:

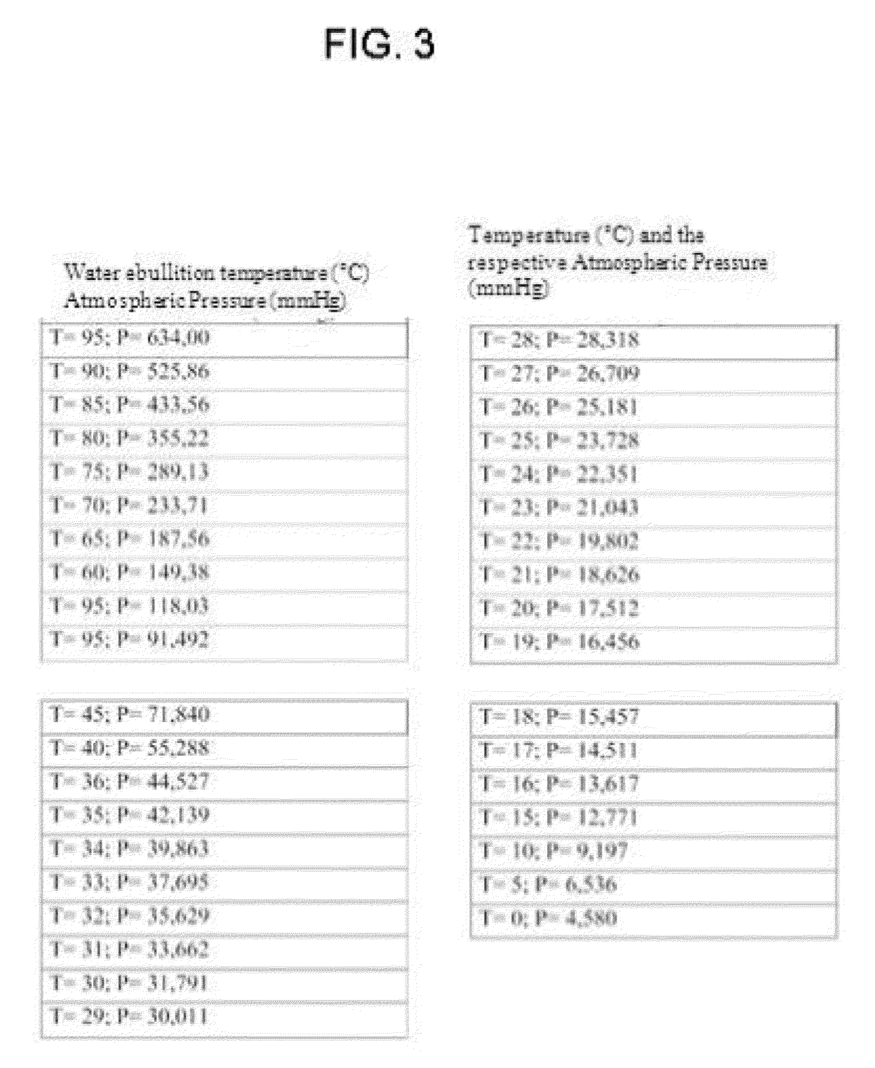

1—the effects of pressure on the water ebullition temperature and its effects on the cells, according to the Table shown in FIG. 3;

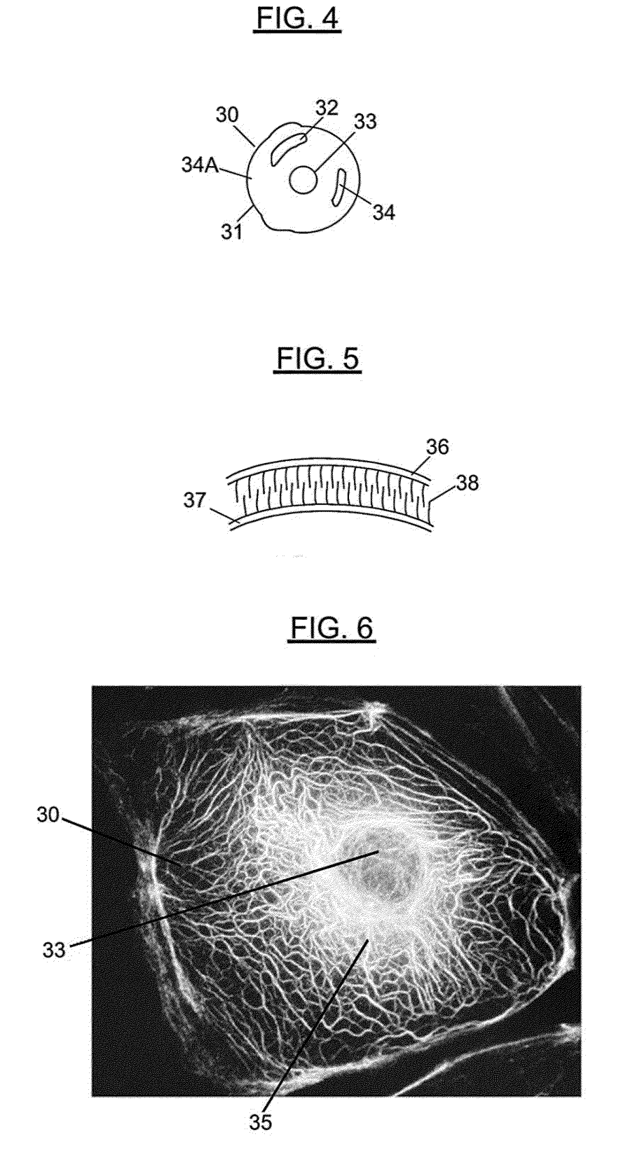

2—the cell morphology, according to FIGS. 4, 5, and 6, which schematically show an eukaryotic cell, the molecular structure of its membranes and the cytoskeleton, such cell structures that do not survive the physical attacks of the process and equipment of the present disclosure and that cause the death of the cells;

3—the lethal effects of the great accelerations on the cell organelles.

Influence of the Pressure Over the Water Ebullition Temperature.

The great and sudden decompression, which causes a great and sudden expansion of the cytoplasmic gases in the microorganisms, also causes, at the same time, the sudden ebullition of the water at low temperatures, which is also lethal to the cells.

The sudden vaporization of the cytoplasmic water along with the great expansion of the natural or insufflated gases in the cytoplasm and in its organelles destroy the cell and organelle membranes of the cell transportation system, thus destroying the homeostasis and killing the cells.

A part of the Table “Water Ebullition Temperature due to Pressure” is shown in FIG. 3; in it we can see that, under the very low pressures that occur in the “PROCESS AND EQUIPMENT FOR STERILIZING LIQUID FOODS AT LOW TEMPERATURE THROUGH DECOMPRESSION AND/OR GREAT LINEAR OR ROTATORY ACCELARATIONS”, the water contained in the cytoplasm, which reaches up to 90% of the weight of the microorganisms, also vaporizes suddenly.

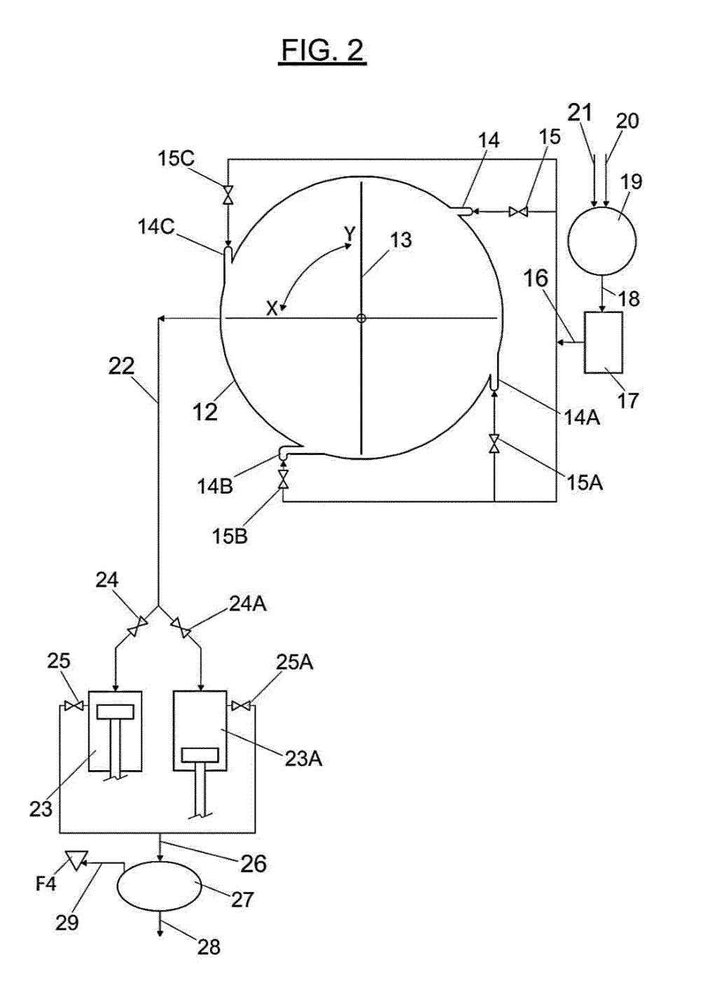

By data interpolation of the Table in FIG. 3, we can see that, at the pressure of 7.6 mm Hg, which corresponds to a hundredth of the atmospheric pressure, the water ebullition temperature is of only 7 degrees Centigrade; if the decompression is being undertaken at around 25 degrees Centigrade, at a pressure of 7.6 mm Hg, despite such low temperature, the water enters ebullition, at cold, with a great and quick expansion as it becomes vapor, which enhances the lethal effects of the gas expansion on the microorganism cells. FIG. 2 is an alternate embodiment of the object of this disclosure, whose innovative core principle consists of applying great accelerations of up to 1,000 times the Gravity of the Earth's surface or more, to the liquids to be treated, conformed in droplets or thin sprays, in fractions of a second, resulting in linear acceleration, rotatory acceleration, or both combined.

FIG. 2 is a schematic view of a second embodiment of the “PROCESS AND EQUIPMENT FOR STERILIZING LIQUID FOODS AT LOW TEMPERATURE THROUGH DECOMPRESSION AND/OR GREAT LINEAR OR ROTATORY ACCELARATIONS”, that acts according to the second core principle of the object of this disclosure, which is to destroy the cells of the contaminative microorganisms in the liquids to be treated, conformed in liquid thin sprays or droplets by subjecting them to great linear accelerations of up to 1,000 times the value of the gravity on earth surface in a few milliseconds. In this embodiment, a four-blade blower (12) with rotor (13) having four blades which turn towards the curvilinear arrow (X-Y). Injector nozzles (14), (14A), (14B) and (14C) conform the liquids to be treated into thin liquid sprays or droplets and inject them into blower (12), following a rectilinear path opposite to the direction of the blades of the rotor (13). Admission valves (15), (15A), (15B) and (15C), controlled by specific software, are fed by conduit (16), which receives the liquids to be treated at high pressures from liquid compression system (17), which can work by compression pistons, by rotary pumps or by any other suitable way. Liquid compression system (17) receives the liquids to be treated through duct (18) from tank (19), which holds the products to be treated. Tank (19) receives the liquids to be treated through feeding duct (20) and sterile gas through gas feeding duct (21).

FIG. 2 also shows the liquids treated by the very high accelerations imposed on them by the rotation of rotor (13) and blower (12) leave the blower (12) through exit conduit (22). Treated liquids leave blower (12) due to aspiration performed by piston-aspirating cylinders (23) and (23A), which operate in counter-phase. Valves (24) and (24A), also operate in counter-phase together with valves (25) and (25A) which, in an operational counter-phase set, control the input and output, made alternately, of the liquids to be treated inside the piston-aspirating cylinders (23) and (23A). Treated liquids exit cylinders (23) and (23A) through valves (25) and (25A) and travel through exit duct (26), to tank (27). Treated liquids are bottled through exit duct (28). The tank of treated products (27) maintains a pressure that is slightly higher than 1 atmosphere. Tank (27) communicates with the environmental air through duct (29) and sterilizing filter (F4).

The equipment functions as follows: the liquids to be treated enter the tank of the products to be treated (19) through feeding duct (20). Sterile gas enters tank (19) through gas feeding duct (21). The liquids to be treated and sterile gas then enter liquid compression system (17), which consists of compression pistons, rotary pumps or any other suitable way of performing high pressures over the liquids to be treated.

The liquids, under high pressures of up to 200 kilograms per square centimeter, are taken through duct (16) to injection nozzles (14), (14A), (14B) and (14C), through which the liquids to be treated are injected inside blower (12), conformed in liquid thin sprays or droplets, towards the opposite direction of the rotation of the blades of rotor (13). Admission valves (15), (15A), (15B) and (15C) control the entry of these liquids to be treated into the blower (12). The exit conduit of the treated liquids (22), leads the treated liquids to be aspirated by piston-aspirating cylinders (23) and (23A), which operate in counter-phase. Treated liquids enter piston-aspirating cylinders (23) and (23A) through valves (24) and (24A). Valves (25) and (25A), which operate in counter-phase, take the treated and aspirated liquids, after having been sterilized, through exit duct (28) to the tank of treated products (27). The pressure over treated liquids in tank (27) is kept slightly higher than the local atmospheric pressure, through duct (29) and sterilizing filter (F4). Finally, treated liquids travel through the exit duct (28) to bottling.

All the pieces of equipment described in each embodiment described herein is controlled by specific software that automates the equipment to produce the described methods.

Morphology of the Bacterial Cells and of their Membranes.

FIG. 4 is a schematic sectional view of a eukaryotic cell (30) with the front removed. The eukaryotic cell (30) includes a cell membrane (31), a cytoplasmic organelle (32), the cell nucleus (33) and a mitochondrion (34), the “power plant of the cell”, such organelle also being limited by a membrane that is similar to its cell membrane (31), that absorbs the oxygen passively diffused from the environment into the interior of the cytoplasm through the cell membrane (31) for the production of the energy needed to function and that also produces carbon dioxide as a result of oxidation in a reaction that is inverse to photosynthesis.

The presence of these two gases inside the mitochondrion (34) and the cytoplasm is the target of the first two core principles, objects of this disclosure, which through a great and sudden decompression, will make the gases expand and will explode the cell membrane and the membrane of its organelles, thus killing the cell.

FIG. 5 schematically shows the composition of the phospholipid bilayer of the cell membrane; in it, we can see the external hydrophilic phospholipid bilayer (36), the internal hydrophilic phospholipid bilayer (37) and the intermediate hydrophobic lipidic layer (38). The hydrophilic character of the hydrophilic layers is due to the fact that the polarized phosphate radicals lie there whereas the hydrophobic character of the intermediate layer is due to the neutral character of the long-chain fatty acids.

The phospholipid bilayer structure, which forms the cell membrane, separates the “chaos” from the extremely organized intracellular setting; outside the membrane, the chaos; in its interior, the life, the order.

FIG. 6 shows, in an immunofluorescence photograph in a dark area, one of the most complex and dynamic organelles of the cell structure: the cytoskeleton (35) of the cell (30) with its nucleus (33). The cytoskeleton consists of fibrillary protein complexes formed by the polymerizations of the proteins; its functions are countless, among which we will mention:

a—coordinating the spatial distribution, that is, establishing the organelle architecture inside the cell and establishing its correct anatomy and physiology; the cellular physiology is extremely dependent upon the spatial relations between its organelles;

b—keeping the cellular shapes, typical of the species;

c—providing the cellular movements;

d—providing the support for the physical and spatial organization of the cell itself and with the neighboring cells;

e—providing cell resistance against the mechanical influences performed by the environment;

f—receiving and sending communication between the cell and the environment by means of messenger molecules and observing contact forces, temperature, pH, salinity and the presence of other cells. Cancers that form tumors, in which the reproduction of metaplastic cells are not inhibited by the contact or pressure of other cells, are currently considered metabolic diseases of the cytoskeleton, which keeps forming the aster needed for the mitosis, in spite of receiving information from the outside for not doing so.

It is easy to notice that, when the cells are subjected to the accelerations, whether linear or rotatory or both combined, in a millisecond, that can reach up to a 1,000 times the gravitational acceleration on the surface of Earth, the cytoskeleton (35) is violently destroyed, the organelles get disorganized and the cells die by physical destruction.

Lethal Effects of Great Accelerations on the Cytoskeleton.

The basic description of the cell morphology has been provided to aid in understanding the effects of the huge accelerations imposed in milliseconds to the cells of the contaminative microorganisms. It is important to remember that the physical constitutions of such microorganisms, according to FIG. 6—whether they are bacteria, fungi or protozoan—do not have any defense against accelerations, as they have densities which are close to that of the water, environment where they live in suspension and, therefore, their supporting organs are only a slighlty more resistant than necessary to support their own weight in under water immersion conditions. Their structural constitutions, which come from hundreds of millions of years of evolution, shape them in a proteic gel that is extremely complex, defined and differentiated by microtubules and delicate functional membranes that, due to the delicacy of the materials from which they are built, do not have any defense against great accelerations.

In case such microorganisms are subjected to great accelerations—whether they are applied linearly, rotatorily or both combined—the architectures of their organelle and of their cytoskeleton, as well as the spatial and functional relations of their organelles, are destroyed, their physiologies collapse and they die.

One of the ways for obtaining such accelerations is by throwing the liquid food, conformed in droplets or fine sprays, at high speeds, at any angle, in the opposite direction of the rotation of the blower blade faces, which can be orthogonal or oblique, in relation to the direction of the jets sprayed on them, or they can be lined up in any kind of curve, such as the blowers blades, shapes that make linear or rotatory accelerations simultaneously.

Here is what happens when such jet of the liquid reaches, in the opposite direction, the blades of the mentioned 4-blade blower of the “PROCESS AND EQUIPMENT FOR STERILIZING LIQUID FOODS AT LOW TEMPERATURE THROUGH DECOMPRESSION AND/OR GREAT LINEAR OR ROTATORY ACCELARATIONS”, object of this disclosure, similar to what is shown in FIG. 2, considering that:

1—the length of each blade from the blower axle is 0.5 meters and its rotation is 3,600 RPM (revolutions per minute) or 60 revolutions per second;

2—the tangential speed of the extremities of the blower blades will be, therefore, 2×3.14×0.5 meter×60 revolutions per second=188 meters per second;

3—the liquid to be processed is thrown in the opposite direction of the tangential speed of the blower blades, at the speed of 20 meters per second or more, in the form of droplets or fine liquid sprays conformed by 4 injection nozzles, with an area of about one square millimeter, with 1 nozzle for each blower blade,

4—this speed of 20 meters per second of the spray of the liquid to be treated is acquired by its compression in a gaseous environment, by neutral gas, like Nitrogen, or when such liquid is subjected to compression injection cylinders, or rotary pumps, whose exit pressures are nearly 100 kilograms per square centimeter, which intensely gasifies the treated-to-be liquid as well as the cytoplasmic interior and organelles of the present contaminative microorganisms,

5—under these conditions, when the spray of the liquid to be treated hits the blower blades, whose extremities move at 188 meters per second, the spray suffers an acceleration that makes it pass from the speed of 20 meters per second, in one direction, to the speed of 188 meters per second in the opposite direction, that is, it receives an acceleration of 208 meters per second squared, an acceleration that happens in fractions of a second, that is, in this case, an acceleration that is nearly 750 times the Gravity on the Earth's surface, which is absolutely unbearable for the delicate protein threading that configures the cell architecture, like its protein cytoskeleton, its cell membranes and its organelle membranes, constituted in lipidic-proteic gel, dependent upon their reciprocal spatial relations to be able to perform the biochemical functions, whose functions are called life.

All the complex and dynamic protein constructions that constitute the living cells—and their organelles—are mechanically destroyed in these shocks by the sudden acceleration, which is incompatible with the structural resistance of their compounds, resulting in death of all the cells, without exception.

The great accelerations, mostly rotatory, applied to the microorganisms can be compared with the effects that the tennis players apply to the tennis balls. When tennis players hit tennis balls with rackets, the rackets apply tangential accelerations onto the surfaces of the balls. When such accelerations are great, due to the inertia of the tennis balls in relation to the reaction to the applied forces, the filaments of the tissues that cover the tennis balls are rubbed away and the resistant vulcanized rubber, which the tennis balls are made of, suffers from serious material fatigue.

The same happens, even more seriously, with the cytoskeleton of the microorganism cells as they receive great tangential accelerations.

As stated before, sterilization is a dichotomic concept: either it is total or it is not sterilization, for if one single viable microorganism is left, the population will recover itself.

In the pasteurization process at relatively low temperatures, up to 99.9% of the contaminative organisms are eliminated and, therefore, the liquid foods treated by it have short shelf life and they need to be kept cool. In the case of pasteurization by the UHT—Ultra-High Temperature—process, 100% of the contaminative organisms are eliminated with serious losses of nutrients, colors and tastes of the products to be treated, which can no longer be used for the industrialization of any dairy product, although they have a long shelf life and do not need to be kept cool.

1-28. (canceled)

29. A method for sterilizing liquid foods at low temperature through decompression, said method comprising:
producing, in fractions of a second, a great and sudden decompression in order to cause a great and sudden expansion of the gases present in the cytoplasmic liquids and in the liquids inside the organelles of the contaminative organisms;
wherein the cell walls, cell membranes and organelles of contaminative organisms are destroyed; and
wherein all molecules of nutrients within said liquid foods are preserved.

30. The method of claim 29, further comprising the step of gasifying the liquid to be treated with pure nitrogen, carbon dioxide or other neutral gases prior to the step of producing a great and sudden decompression.

31. The method of claim 29, further comprising the step of:
ultrasound, microwave and heterogeneous photocatalysis irradiation, performed by irradiating white light and/or ultraviolet light over resin-covered or ceramic surfaces with nanostructured particles, singly applied or combined in any way, and sudden vaporization of intracell water;
wherein said irradiation is performed by equipment specially developed for that purpose.

32. The method of claim 29, further comprising the step of:
applying microwave irradiations, solely applied or combined in any form, with frequency of 2,450 MHz, ultrasound with frequencies between 30 kHz and 5 MHz and heterogeneous photocatalysis caused by the irradiation of white and/or ultraviolet light over surfaces covered by resins or ceramics, with nanostructured particles, of silver, titanium dioxide, zirconium dioxide, tin dioxide and other similar compounds.

33. The method of claim 29, further comprising the steps of:
gasifying said liquid foods in gasification vessels under pressures of up to 200 kg/cm²;
wherein said step of gasifying includes slowly injecting gases until reaching high pressures.

34. The method of claim 33, wherein said gas is selected from the group comprising carbon dioxide and nitrogen.

35. The method of claim 29, further comprising the step of heating said liquids to be treated before or after submitting said liquids to said method.

36. The method according to claim 29, wherein the equipment which produces the great decompressions comprises:
a decompression tank;
a first piston inside said decompression tank;
said first piston connected to a rod;
said piston and said rod operated by an oil pump;
a sterile gas tank;
a relief duct connecting said sterile gas tank to said decompression tank;
a tank containing liquid to be treated;
a first sterilizing filter having a first end and a second end;
said first end of said first sterilizing filter in communication with the atmosphere;
said second end of said first sterilizing filter connected to said tank;
said tank receiving its content through a duct;
a feeding duct having a first end and a second end;
said first end of said feeding duct connected to said tank;
said second end of said feeding duct connected to a second piston;
said feeding duct under the control of a valve;
said second piston connected to a second duct;
said second duct having a first end and a second end;
said second piston connected to said first end of said second duct;
said second end of said second duct connected to a decompression tank;
said second duct under the control of a second valve;
an exit duct having a first end and a second end;
said first end of said exit duct connected to said decompression tank;
said second end of said exit duct connected to a storage tank;
said exit duct having a third valve;
a second air sterilizing filter having a first end and a second end;
said first end of said second air sterilizing filter in communication with the atmosphere;
said second end of said second air sterilizing filter connected to said storage tank;
an exit duct for treated liquid having a first end and a second end;
said first end connected to said storage tank;
said second end;
wherein the pressure in said tank is equalized to the atmospheric pressure by means of said first air sterilizing filter;
wherein the pressure in said storage tank is equalized to the atmospheric pressure by means of said second air sterilizing filter;
wherein sterile gas appropriate for food treatment travels from said sterile gas tank to said decompression tank through said relief duct;
wherein the movement of said piston doses said liquid with sterile gas; and
wherein the movement of said piston compresses the liquid to be treated.

37. The equipment of claim 36, wherein said equipment is self-sterilizable.

38. The equipment of claim 36, wherein said equipment is controlled by specialized software.

39. The equipment according to claim 36, wherein sudden and great decompression is caused by displacement of said piston near to a surface of said liquid to be treated.

40. The method according to claim 29, wherein the equipment which produces the great decompressions comprises:
a tank;
said tank containing liquid to be treated;
a feeding duct connected to said tank;
said feeding duct carrying said liquid to be treated to said tank;
a sterile gas duct connected to said tank;
a liquid compression system;
a first duct connecting said tank to said liquid compression system;
at least one injector nozzle;
a conduit connecting said liquid compression system to said at least one injector nozzle;
at least one admission valve;
said at least one admission valve controlling flow of said liquid to be treated to said at least one injector nozzle;
a blower;
said blower having a rotor;
said rotor having at least one blade;
at least two piston-aspirating cylinders;
an exit conduit connecting said blower to said piston-aspirating cylinders;
at least two first valves;
said first valves controlling liquid flow from said conduit to said piston-aspirating cylinders;
a tank of treated products;
an exit duct connecting said piston-aspirating cylinders to said tank of treated products;
at least two second valves;
said second valves controlling liquid flow from said piston-aspirating cylinders to said exit duct;
a sterilizing air filter;
a second duct connecting said sterilizing air filter to said tank of treated products
a second exit duct;
said second exit duct is connected to said tank of treated products;
wherein said injector nozzle conforms liquids to be treated into thin liquid sprays or droplets;
wherein said injector nozzle injected said liquids into said blower;
wherein said blower applies great accelerations of up to 1,000 times the gravity of the Earth's surface or more to the liquids to be treated in fractions of a second, resulting in linear acceleration, rotatory acceleration, or both combined;
wherein said piston-aspirating cylinders aspirate said liquid;
wherein said piston-aspirating cylinders operate in counter-phase;
wherein said first valves and said second valves operate in a counter-phase set, alternating input to and output from said piston-aspirating cylinders;
wherein said treated products exit said tank of treated products through said second exit duct for bottling; and
wherein the tank of treated products maintains an internal pressure of slightly higher than 1 atmosphere because of its communication with environmental air through said sterilizing filter.

41. The equipment of claim 40, wherein said equipment is self-sterilizable.

42. The equipment of claim 40, wherein said equipment is controlled by specialized software.

43. The equipment of claim 40, wherein:
liquids to be treated are continuously ejected into said tank;
wherein said tank has an internal pressures as low as 5/1000 atmospheric pressure; and
wherein said internal pressure is maintained by suction caused by a blower or cylinders.

44. The equipment of claim 35, wherein the sudden and great decompression of said liquids is performed by sets of compressors, rotating pumps, cylinders or injectors.

45. The equipment of claim 40, wherein:
the sudden and great decompression is performed in fractions of seconds;
wherein the liquids to be treated in the form of fine jets or droplets;
wherein said liquids are simultaneously submitted to linear or rotating acceleration, or any combinations of said accelerations, of about 1000 times the gravity acceleration over the Earth surface;
wherein said accelerations are provided by frontal, oblique or tangential shocks from said blower;
wherein said acceleration is applied before the sudden and great decompressions; and
wherein said sudden and great decompression may reach final pressures up to 20,000 times lower than pressures previously existing over said liquids.

46. The equipment of claim 40 wherein the acceleration of said liquids to be treated is performed with said liquids at atmospheric pressure.

47. The equipment of claim 40 wherein the acceleration of said liquids to be treated is performed with said liquids quickly and artificially gasified at any pressure.

48. The equipment of claim 40 wherein the sudden and great decompression is caused by suction of gases by said blower from said tank.
